(19) United States
(12) Patent Application Publication
(10) Pub. No.: US 2008/0132439 A1
(43) Pub. Date: Jun. 5, 2008

(54) Cleaner Composition

(76) Inventors: Akito Itoi, Wakayama (JP); Eiji Kashihara, Wakayama (JP); Katsuhiko Rindo, Wakayama (JP); Ryoichi Hashimoto, Wakayama (JP)

Correspondence Address: BIRCH STEWART KOLASCH & BIRCH, PO BOX 747, FALLS CHURCH, VA, 22040-0747, US

(21) Appl. No.: 11/793,465

(22) PCT Filed: Dec. 21, 2005
(86) PCT No.: PCT/JP05/23518

§ 371 Date: Jun. 20, 2007

(30) Foreign Application Priority Data
Dec. 21, 2004 (JP) 2004-369801
Jun. 27, 2005 (JP) 2005-186534
Nov. 24, 2005 (JP) 2005-338611

(51) Int. Cl. C11D 3/20; C11D 7/08

(52) U.S. Cl. 510/506

(57) ABSTRACT

A cleaning agent composition for a treated tool comprising an alkyl glycoside, a glyceryl ether, a hydrocarbon and water, and a cleaning process using the cleaning agent composition. The cleaning agent composition is used upon washing a surface of a silicone-treated tool, a liquid crystal-treated tool, a copper plate, or the like.

### TECHNICAL FIELD

The present invention relates to a cleaning agent composition. More specifically, the present invention relates to a cleaning agent composition which has excellent removability of stains existing on surfaces of a silicone-treated tool, a liquid crystal-treated tool, a copper plate, or the like and rinsability, and is highly safe, so that the cleaning agent composition can be suitably used for a silicone-treated tool, a liquid crystal-treated tool, a copper plate, or the like. In addition, the present invention relates to a cleaning process of a silicone-treated tool, a liquid crystal-treated tool, or a copper plate, with the cleaning agent composition.

### BACKGROUND ART

Silicones are very important raw materials in the field of paints, in the field of personal care products, or the like, because of their hydrophobicity and peculiar frictional properties. Conventionally, in the cleaning of the formulation facilities after formulating a manufactured article containing a silicone, a general surfactant such as an aqueous solution of a neutral surfactant or an alkylbenzenesulfonate has been used (for example, Patent Publication 1). In addition, a cleaning liquid containing a silicone-containing paint which is more unlikely to be cleaned because of the properties of the silicone and a cleaning process therefor has been reported (for example, Patent Publication 2).

In a liquid crystal compound and a mixture thereof usable in display elements for use in displays for personal computers, television, mobile phones or the like, it is necessary to prevent as much as possible the admixture of an extraneous substance or impurities, or the admixture of a liquid crystal compound that lowers its properties from the viewpoint of the necessity of maintaining the desired properties (for example, phase transfer temperature, response rate, contrast, and the like). In addition, a driving voltage may be high in a narrow cell gap, thereby necessitating the prevention of the admixture of an electroconductive extraneous substance.

In view of the above, a very high level of degree of cleanliness is desired in a liquid crystal-treated tool for treating a liquid crystal compound.

Conventionally, a liquid crystal compound existing on the surface of the liquid crystal-treated tool has been removed with a chlorine-based solvent such as trichloroethane or tetrachloroethylene, a chlorofluorocarbon-based solvent such as trichlorofluoroethane, or the like. However, the chlorine-based or chlorofluorocarbon-based solvent has a disadvantage that there are serious disadvantages in safety, toxicity, working environment, environmental pollution, and the like.

In order to solve this disadvantage, a water-based cleaning agent containing as a main component a non-chlorine-based solvent, a non-chlorofluorocarbon-based solvent, or a surfactant has been proposed (Patent Publication 3).

On the other hand, in the cleaning of surface of a rigid material such as a metal, glass, a ceramic, or a plastic, an alkaline cleaning agent has been widely used conventionally. In the fields where the alkaline cleaning agents are used, the cleaning is carried out by raising the cleaning temperature to a temperature above the room temperature in many cases in order to improve the cleanability. For example, in a case where steel plates (steel strips) in iron works or the like are subjected to continuous cleaning, the cleaning facilities usually have a structure in which the steel plates (steel strips) wound in a coil shape are continuously cleaned, wherein the cleaning is operated at a rate of 30 to 1100 m/minute or so, and the cleaning time for the steel plates is a very short period of time of several seconds at the longest. Therefore, in general, the cleaning agent for a steel plate is used at a cleaning temperature of usually from 60° to 80° C. in order to remove an oily component deposited on surfaces of a steel plate in a short period of time.

As cleaning agent compositions for rigid surfaces as mentioned above, an alkaline cleaning agent composition containing a polyglyceryl ether-type nonionic surfactant and an alkalizing agent (Patent Publication 4); an alkaline cleaning agent composition containing a glyceryl ether, a terpene-based hydrocarbon, a surfactant and an alkalizing agent (Patent Publication 5); and the like have been disclosed.

### Patent Publication 1: JP-A-Hei-2-215897

### Patent Publication 2: JP-A-Hei-6-346010

### Patent Publication 3: JP-A-Hei-4-318100

### Patent Publication 4: JP-A-Hei-5-194999

### Patent Publication 5: JP-A-Hei-11-256200

### DISCLOSURE OF INVENTION

### Problems to be Solved by the Invention

Since a silicone is hydrophobic, a long period of time is required in cleaning the formulation facilities after formulating the manufactured articles. Especially, the removal of a high-viscosity silicone having a kinematic viscosity at 25° C. of 0.01 m²/s or more, and a mixture of the high-viscosity silicone and an amino-modified silicone is very difficult.

Also, a colorant such as a pigment or a dye may be mixed with a silicone in some cases depending upon the applications of silicones. There is a disadvantage in the aspect of quality, such as the mixture is admixed in the next production item unless the formulation facilities used in mixing the mixture as mentioned above are quickly cleaned to a certain level of degree of cleanliness. In order to eliminate the disadvantage as mentioned above, conventionally, employees entered into the formulation facilities, and wiped off the admixture with a cleaning instrument such as a scrubber or a sponge, so that there are some disadvantages in the aspect of productivity and operability.

Regarding the disadvantages as mentioned above, there is a disadvantage in the cleaning agent disclosed in the above-mentioned Patent Publication 1 that the cleaning power is not sufficient, and there is also a disadvantage in a cleaning liquid disclosed in the above-mentioned Patent Publication 2 that a high-concentration alkali must be used under high temperatures, thereby making it disadvantageous in the aspect of safety.

Therefore, an object of the present invention is to provide a cleaning agent composition for a silicone-treated tool showing excellent solubility and removability for a silicone and a mixture thereof on the silicone-treated tool and especially being capable of significantly improving rinsability, which has so far been a rate-limiting step, and being capable of reducing loads to the environment, and highly safe; and a cleaning process for a silicone-treated tool with the cleaning agent composition.

In addition, in the cleaning process with a conventional chlorine-based solvent, in the cleaning steps a liquid crystal-treated tool is cleaned with a chlorine-based solvent, the tool is cleaned with a fresh liquid of a chlorine-based solvent, and further with a hydrophilic solution, and subsequently the tool is rinsed with pure water for nearly 10 times, so that 10 or more times of treatments must be carried out in both the cleaning and rinsing steps. On the other hand, in a case where a liquid crystal-treated tool is cleaned with a water-based cleaning agent which has been proposed as a substitute of a chlorine-based solvent, sufficient solubility and removability of a liquid crystal compound deposited to a liquid crystal-treated tool, especially a liquid crystal-formulated vessel which is more unlikely to be subjected to ultrasonic cleaning, cannot be obtained in the cleaning steps, so that it would have been difficult to obtain a high level of cleanability that is necessary for a liquid crystal compound-treated tool. In addition, in a case where a conventional cleaning agent is used in cleaning a liquid, crystal-treated tool, the load upon washing away cleaning agent components deposited on the liquid crystal-treated tool with water, i.e. upon rinsing would have been heavy.

Therefore, an object of the present invention is to provide a cleaning agent composition for a liquid crystal-treated tool showing excellent solubility and removability for a liquid crystal compound deposited on the liquid crystal-treated tool and moreover being capable of significantly improving rinsability, and having a very small risk of environmental pollution, and being highly safe; and a cleaning process for a liquid crystal-treated tool with the cleaning agent composition.

On the other hand, the cleaning agent compositions disclosed in Patent Publications 4 and 5 cannot be said to be sufficient from the aspect of repeated cleanability, low-foamability, and the like under the cleaning conditions of low temperatures (50° C. or less) and a short period of time.

Further, when the cleaning is carried out for a long period of time with the conventional cleaning agent composition as mentioned above, the pH is more likely to be lowered; therefore, when a cleaning agent composition of which pH is lowered is used for, for example, a precision part made of aluminum or the like, there are some cases where the corrosion of aluminum is disadvantageous. Therefore, an exchange of a cleaning liquid is necessary even if a drastic lowering of the cleaning power itself is not found. In addition, the lowered pH leads to the lowering of the cleaning power beyond the lowering of the cleaning power that would have been ordinarily considered, so that the exchange cycle for the cleaning liquid may have to be shortened in some cases.

Therefore, an object of the present invention is to provide a cleaning agent composition for rigid surfaces, being capable of widely used for various stains on rigid surfaces, especially a copper plate surface, having smaller pH fluctuations, showing stable solubility and removability for these stains even in the cleaning at low temperatures, being capable of significantly improving rinsability, which has so far been a rate-limiting step, and being capable of reducing loads to the environment, and highly safe; and a cleaning process for rigid surfaces with the cleaning agent composition.

### Means to Solve the Problems

Specifically, the gist of the present invention relates to:

[1] a cleaning agent composition containing an alkyl glycoside, a glyceryl ether, a hydrocarbon compound and water;
[2] the cleaning agent composition according to the above [1], of which application is a silicone-treated tool, a liquid crystal-treated tool, or a copper plate; and
[3] a cleaning process including the step of cleaning a silicone-treated tool, a liquid crystal-treated tool, or a copper plate with the cleaning agent composition as defined in the above [1].

### EFFECTS OF THE INVENTION

According to the present invention, a cleaning agent composition for a silicone-treated tool showing excellent solubility and removability for a silicone and a mixture thereof on the silicone-treated tool and being capable of significantly improving rinsability, which has so far been a rate-limiting step, and being capable of reducing loads to the environment, and highly safe can be provided, and a cleaning process for a silicone-treated tool capable of safely cleaning the silicone-treated tool can be provided.

In addition, the cleaning agent composition of the present invention can be utilized in the cleaning of a liquid crystal-treated tool desired to have a very high level of degree of cleanliness.

Furthermore, according to the cleaning agent composition of the present invention, a cleaning agent composition for rigid surfaces, being capable of widely used for various stains on rigid surfaces, especially a copper plate surface, having smaller pH fluctuations, showing stable solubility and removability for these stains even in the cleaning at low temperatures, being capable of significantly improving rinsability, which has so far been a rate-limiting step, and being capable of reducing loads to the environment, and highly safe can be provided; and a cleaning process for rigid surfaces, capable of safely cleaning surfaces of a rigid material such as a precision part, a jig or tool, a metal, glass, a ceramic or a plastic can be provided.

### BEST MODE FOR CARRYING OUT THE INVENTION

One of the features of the cleaning agent composition of the present invention resides in that the cleaning agent composition contains an alkyl glycoside, a glyceryl ether, a hydrocarbon compound, and water, wherein the four components are used together.

Especially, in the present invention, by combining an alkyl glycoside and a glyceryl ether, a hydrocarbon compound that is inherently insoluble in water can be dispersed even in a high-water content region. Therefore, a silicone and a mixture thereof can be dissolved and removed even at a high water content, so that not only the cost for the cleaning agent can be significantly reduced, but also handling is facilitated because a strict water content management with consideration of inflammability is not necessary as compared to a conventional cleaning agent.

In addition, while a conventional water-based cleaning agent containing a hydrocarbon had heavy loads upon rinsing for washing away cleaning agent components deposited on an object to be cleaned and oily stains redeposited thereon, the rinsing is remarkably facilitated with the cleaning agent composition of the present invention.

While a conventional cleaning agent had heavy loads upon rinsing with water for washing away cleaning agent components remaining on a liquid crystal-treated tool, the rinsing with water is remarkably facilitated with the cleaning agent composition of the present invention. The cleaning agent composition of the present invention has an especially excellent effect for removing a liquid crystal compound deposited on a liquid crystal-treated tool.

In addition, the cleaning agent composition of the present invention exhibits an effect that liquid crystals existing between gaps of the liquid crystal cells can be cleaned, so that liquid crystal stains existing within the narrow liquid crystal cells between gaps of which cleaning had been conventionally difficult can be cleaned.

The cleaning agent composition of the present invention has a sufficient cleanability of a silicone-treated tool even at a low temperature, and shows more excellent cleanability than a previously shown known cleaning agent even at a temperature higher than 50° C.

<<Object to be Cleaned>>

The silicone-treated tool, which serves as an object to be cleaned of the present invention, includes a silicone formulation facility usable upon mixing a silicone, a jig or tool usable in handling a silicone, and the like. The silicone formulation facility in the present invention refers to a vessel, a pump of a filling line, a pipe, a tank such as a relay tank which is usable upon the preparation of a silicone and a mixture thereof for use in cosmetics for washing hair, such as shampoos and conditioners; makeup cosmetics such as foundation; sunscreen cosmetics; lip cosmetics; eyeliner cosmetics; defoaming agents; mold releasing agents applied to a mold upon resin-molding processing; surfactants for polyurethanes, PVC, and phenol foams; silicone-formulated paints; and the like. In addition, the jig or tool in the present invention refers to a jig or tool in general which has a possibility of contacting with a silicone, such as a filling machine nozzle, for use in filling a manufactured article containing a silicone in a vessel and producing a manufactured article.

The liquid crystal-treated tool, which serves as an object to be cleaned of the present invention, includes a liquid crystal formulation tank usable upon mixing a liquid crystal compound, a jig or tool usable upon pouring or a dropping a liquid crystal on a display element substrate, and the like. The liquid crystal formulation tank in the present invention refers to a container (for example, a container made of SUS steel) usable upon preparing a liquid crystal compound and a mixture thereof, for use in a display element such as a display for personal computers, television, or mobile phones. In addition, the jig or tool usable in handling a liquid crystal in the present invention refers to a container filled with a liquid crystal, a jig to which a glass substrate is fixed, a tank, a pipe, a pump, and a nozzle portion of an apparatus usable upon dropping a liquid crystal to a glass substrate, or the like, the jig or tool being usable upon encapsulating a liquid crystal compound to the glass substrate, and refers to a jig or tool in general that has possibilities of being stained by a liquid crystal compound.

The copper plate, which serves as an object to be cleaned of the present invention, refers to a copper plate in a precision part, a jig or tool, or the like, which is an object to be cleaned.

In the present invention, the precision part refers to, for example, an electronic part, an electric part, or the like. The electronic part includes, for example, semiconductor packages, printed circuit boards, IC leads, and the like. The electric part includes, for example, electric motor parts such as brush, rotor, and housing, and the like.

The cleaning agent composition of the present invention exhibits a high removability for a liquid crystal compound deposited to a liquid crystal formulation tank which is difficult to be subjected to a ultrasonic cleaning effective especially as a physical cleaning means of those mentioned above.

<<Object to be Removed>>

The silicone and a mixture thereof, which are subjects to be removed by the cleaning agent composition of the present invention is generally a silicone oil having fluidity. The silicone includes modified silicones such as methyl polysiloxanes, polymerized methyl polysiloxanes, and polymerized dimethyl siloxane-methyl(aminopropyl)siloxane copolymers, and the like. Among them, it is very difficult to clean away a mixture containing a high-viscosity modified silicone, such as a polymerized methyl polysiloxane, of which kinematic viscosity at 25° C. is 0.01 m²/s or more and/or an amino-modified silicone such as a polymerized dimethyl siloxane-methyl(aminopropyl)siloxane copolymer. Therefore, the cleaning agent composition of the present invention is used so that especially a high-viscosity modified silicone and an amino-modified silicone are subjects to be removed.

In addition, in a case where a liquid crystal compound, which is a subject to be removed by the cleaning agent composition of the present invention, is in general used in a display element for displays for a personal computer, television, a mobile phone, or the like, about twenty kinds of materials such as ester-based materials, biphenyl-based materials, dioxane-based materials, and phenyl cyclohexane-based materials are mixed, and strictly weighed according to their purposes such as temperature properties, voltage properties, and elastic properties. Therefore, upon mixing the liquid crystal compound, there is a great possibility of influencing the above properties even if a very small amount of impurities and/or the liquid crystal mixture previously formulated thereto is admixed slightly; therefore, a high level of cleanliness is desired in a liquid crystal formulation tank usable in the mixing or a jig or tool for handling the liquid crystal compound. The liquid crystal compound includes a nematic liquid crystal, a cholesteric liquid crystal, a smectic liquid crystal, and the like, for use in display devices such as TN, STN, TFT, and MIM.

The main subject to be removed in the copper plate by the cleaning agent composition of the present invention is various stains such as liquid crystals, oily components, or flux (residue generated upon soldering) deposited on surfaces of a copper plate. The cleaning agent composition of the present invention exhibits a high cleanability especially for flux remaining on a semiconductor package or a printed circuit board, or a processing oil deposited on surfaces of a copper plate upon plastic working. Further, the cleaning agent composition also exhibits high cleanability for stains in which a metal powder, an inorganic substance powder, water, or the like is admixed with these subjects to be removed.

<<Alkyl Glucoside>>

The alkyl glycoside usable in the present invention is capable of dispersing a hydrocarbon compound that is inherently insoluble in water even in a high-water content region, and dissolving and removing a silicone and a mixture thereof, by using the alkyl glycoside in combination with a glyceryl ether.

The alkyl glycoside usable in the present invention is represented by the following general formula (1):

R¹(OR²)ₓG_{y} (1)

wherein R¹ is a linear or branched, alkyl group, alkenyl group, or alkylphenyl group, each having 8 to 18 carbon atoms; R² is an alkylene group having 2 to 4 carbon atoms; G is a residue originated from a reducing sugar having 5 or 6 carbon atoms; x (average) is from 0 to 5; and y (average) is from 1 to 5.

In the formula, x is preferably from 0 to 2, and more preferably 0, and y is preferably from 1 to 1.5, and more preferably from 1 to 1.4. The number of carbon atoms of R¹ is preferably from 9 to 16, and more preferably from 10 to 14, from the viewpoint of solubility and removability. R² is preferably an ethylene group. G has a structure determined by a monosaccharide or polysaccharide used as a raw material. The monosaccharide includes glucose, galactose, xylose, mannose, lyxose, arabinose, mixtures thereof, and the like; and the polysaccharide includes maltose, xylobiose, isomaltose, cellobiose, gentiobiose, lactose, sucrose, nigerose, turanose, raffinose, gentianose, melezitose, mixtures thereof, and the like. Among them, the monosaccharide is preferably glucose or fructose, from the viewpoint of availability and low costs, and the polysaccharide is preferably maltose or sucrose. Here, x and y are determined by proton (¹H) NMR.

The alkyl glycoside is not particularly limited, as long as the alkyl glycoside satisfies the above-mentioned general formula (1). For example, an alkyl polyglucoside is preferable from the viewpoint of obtaining high solubility and removability. Among them, a decyl polyglucoside, a dodecyl polyglucoside, a myristyl polyglucoside, and the like are more preferable.

The alkyl polyglucoside as used herein refers to an alkyl glycoside represented by the above general formula (1), wherein G is a residue derived from glucose, and y is 1 or larger, and the alkyl polyglucoside includes, for example, those containing a monosaccharide or a polysaccharide as its structure.

For cleaning a silicone-treated tool, the proportion of the alkyl glycoside to the total amount of the alkyl glycoside, the glyceryl ether, and the hydrocarbon compound is preferably from 20 to 80% by weight, more preferably from 20 to 70% by weight, even more preferably from 25 to 65% by weight, still even more preferably from 30 to 60% by weight, and still even more preferably from 35 to 57% by weight, from the viewpoint of obtaining high rinsability.

For cleaning a liquid crystal-treated tool, the alkyl glycoside is contained in the cleaning agent composition in an amount of preferably from 1 to 80% by weight, more preferably from 1 to 50% by weight, even more preferably from 2 to 40% by weight, and especially preferably from 5 to 30% by weight, from the viewpoint of obtaining high rinsability.

In addition, for cleaning a copper plate, the proportion of the alkyl glycoside to the total amount of the alkyl glycoside, the glyceryl ether, and the hydrocarbon is preferably from 20 to 80% by weight, more preferably from 30 to 75% by weight, even more preferably from 40 to 70% by weight, still even more preferably from 40 to 65% by weight, and still even more preferably from 40 to 62% by weight, from the viewpoint of obtaining high rinsability.

<<Glyceryl Ether>>

The glyceryl ether usable in the present invention includes those having a linear or branched, alkyl group or alkenyl group having 4 to 12 carbon atoms, from the viewpoint of not lowering solubility and removability, and maintaining the properties of a transparent manufactured article within an operable temperature, and the glyceryl ether is preferably, for example, those having an alkyl group having 4 to 12 carbon atoms, such as an n-butyl group, an isobutyl group, an n-hexyl group, an isohexyl group, an n-heptyl group, an n-octyl group, a 2-ethylhexyl group, an n-nonyl group, or an n-decyl group are preferable, and those having one or two alkyl groups, and especially one alkyl group, having 5 to 10 carbon atoms, and even more 5 to 8 carbon atoms, are even more preferable. Further, the glyceryl ether used in the present invention may be a monoalkyl diglyceryl ether or a monoalkyl polyglyceryl ether, in which two or more glyceryl groups, preferably two or three glyceryl groups, are linked with an ether bond. Especially, the monoalkyl glyceryl ether and the monoalkyl diglyceryl ether are preferable, from the viewpoint of having excellent solubility and removability for the silicone or a mixture thereof. An especially preferable glyceryl ether is 2-ethylhexyl glyceryl ether. These glyceryl ethers may be used alone or in admixture of two or more kinds. In the present invention, since the glyceryl ether is used, the dispersibility of the organic solvent and water can be stabilized; therefore, there is an advantage that even more excellent solubility and removability are obtained for a high-viscosity modified silicone or a mixture thereof, which has been conventionally said to be more unlikely to be cleaned.

In the cleaning of a silicone-treated tool, the proportion of the glyceryl ether to a total amount of the alkyl glycoside, the glyceryl ether, and the hydrocarbon compound is preferably from 2 to 30% by weight, more preferably from 3 to 25% by weight, even more preferably from 4 to 20% by weight, even more preferably from 6 to 17% by weight, and even more preferably from 8 to 14% by weight, of the components excluding water from the cleaning agent composition, from the viewpoint of stabilizing the dispersion of the hydrocarbon compound and water, thereby satisfying both high cleanability and rinsability.

In the cleaning of a liquid crystal-treated tool, the glyceryl ether is contained in an amount of preferably from 0.5 to 80% by weight, more preferably from 0.5 to 50% by weight, even more preferably from 1 to 30% by weight, and especially preferably from 1 to 20% by weight, of the cleaning agent composition, from the viewpoint of stabilizing the dispersion of the hydrocarbon compound and water, thereby satisfying both high removability and rinsability.

In the cleaning of a copper plate, the proportion of the glyceryl ether to a total amount of the alkyl glycoside, the glyceryl ether, and the hydrocarbon is preferably from 2 to 70% by weight, more preferably from 2.5 to 65% by weight, and even more preferably from 3 to 60% by weight, from the viewpoint of stabilizing the dispersion of the hydrocarbon and water, thereby satisfying both high cleanability and rinsability. In addition, the proportion is preferably from 5 to 30% by weight, more preferably from 8 to 20% by weight, and even more preferably from 10 to 18% by weight, from the viewpoint of excellently maintaining oil-water separability of the cleaning agent composition. The oil-water separability refers to an ability of separating a free water or free oil from an oil-water liquid mixture, in which the more excellent the oil-water separability, the admixture of the oily components into the wastewater can be reduced, whereby the loads during the wastewater treatment can be lowered.

<<Weight Ratio of Alkyl Glycoside to Glyceryl Ether>>

In the cleaning of a silicone-treated tool, a weight ratio of the alkyl glycoside to the glyceryl ether, i.e. alkyl glycoside/glyceryl ether, is preferably from 2.7 to 10. Among them, in a case where the silicone-treated tool is cleaned, the weight ratio of the alkyl glycoside/glyceryl ether is preferably 10 or less, from the viewpoint of suppressing foamability during cleaning, and the weight ratio is preferably 2.7 or more, from the viewpoint of stably dispersing the hydrocarbon compound and water. Therefore, the weight ratio of the alkyl glycoside/glyceryl ether is more preferably from 2.8 to 6.7, even more preferably from 3.3 to 6.3, and still even more preferably from 3.5 to 5.

In the cleaning of a liquid crystal-treated tool, a weight ratio of the alkyl glycoside/glyceryl ether, is preferably 10 or less, from the viewpoint of suppressing foamability during cleaning, and the weight ratio is preferably 1 or more, from the viewpoint of stably dispersing the hydrocarbon compound and water. Therefore, the weight ratio of the alkyl glycoside/glyceryl ether is preferably from 1 to 10, more preferably from 3 to 8, and even more preferably from 3 to 6.

In the cleaning of a copper plate, a weight ratio of the alkyl glycoside to the glyceryl ether, i.e. alkyl glycoside/glyceryl ether, is preferably from 0.28 to 40. Among them, the weight ratio of the alkyl glycoside/glyceryl ether is preferably 20 or less, from the viewpoint of suppressing foamability during cleaning, and the weight ratio is preferably 0.5 or more, from the viewpoint of stably dispersing the hydrocarbon and water. In addition, the weight ratio is preferably from 1 to 10, more preferably from 2 to 7, and even more preferably from 3 to 6, from the viewpoint of excellently maintaining the oil-water dispersibility of the cleaning agent composition. Therefore, the weight ratio of the alkyl glycoside/glyceryl ether is more preferably from 0.5 to 20, even more preferably from 0.75 to 20, still even more preferably from 0.75 to 17, still even more preferably from 1 to 10, still even more preferably from 2 to 7, and still even more preferably from 3 to 6.

<<Hydrocarbon Compound>>

The hydrocarbon compound usable in the present invention is preferably an olefin-based hydrocarbon compound and/or a paraffin-based hydrocarbon compound. The olefin-based hydrocarbon compound and the paraffin-based hydrocarbon compound is preferably a compound having 10 to 18 carbon atoms, and preferably 10 to 14 carbon atoms, and includes, for example, linear or branched, saturated or unsaturated hydrocarbon compounds, such as decane, dodecane, tetradecane, hexadecane, octadecane, decene, dodecene, tetradecene, hexadecene, and octadecene; alicyclic hydrocarbon compounds such as cyclo compounds such as cyclodecane and cyclododecene; and the like. Among them, linear or branched, saturated or unsaturated hydrocarbon compounds having 10 to 18 carbon atoms, and preferably 10 to 14 carbon atoms are preferable, and olefin-based hydrocarbon compounds are more preferable. These hydrocarbon compounds may be used alone or in admixture of two or more kinds.

In addition, in the present invention, in addition to the olefin-based hydrocarbon compound and the paraffin-based hydrocarbon compound mentioned above, an aromatic hydrocarbon compound such as an alkylbenzene such as nonylbenzene or dodecylbenzene, or a naphthalene compound such as methylnaphthalene or dimethylnaphthalene can be used.

In the cleaning of a liquid crystal-treated tool, the hydrocarbon compound usable in the present invention is preferably a compound having 10 to 18 carbon atoms, and the hydrocarbon compound includes, for example, linear or branched, saturated or unsaturated hydrocarbon-based solvents, such as decane, dodecane, tetradecane, hexadecane, octadecane, decene, dodecene, tetradecene, hexadecene, and octadecene; aromatic hydrocarbon-based solvents such as alkylbenzenes such as nonylbenzene and dodecylbenzene, and naphthalene compounds such as methylnaphthalene and dimethylnaphthalene; alicyclic hydrocarbon-based solvents such as cyclo compounds such as cyclodecane and cyclododecene; and the like. Among them, linear or branched, saturated or unsaturated hydrocarbon compounds having 10 to 18 carbon atoms are preferable, the olefin-based hydrocarbon compound or the paraffin-based hydrocarbon compound is more preferable, and the olefin-based hydrocarbon compound is especially preferable. These hydrocarbon compounds may be used alone or admixture of two or more kinds.

In the cleaning of a silicone-treated tool, the proportion of the hydrocarbon compound to a total amount of the alkyl glycoside, the glyceryl ether, and the hydrocarbon compound is preferably from 10 to 50% by weight, more preferably from 15 to 45% by weight, even more preferably from 17 to 43% by weight, still even more preferably from 20 to 40% by weight, and still even more preferably from 25 to 35% by weight, of the components excluding water from the cleaning agent composition, from the viewpoint of stabilizing the dispersion of the hydrocarbon compound and water, thereby satisfying both high cleanability and rinsability.

In the cleaning of a liquid crystal-treated tool, the hydrocarbon compound is contained in the cleaning agent composition in an amount of preferably from 0.1 to 80% by weight, and more preferably from 0.5 to 50% by weight, from the viewpoint of obtaining a high removability, and the hydrocarbon compound is contained in an amount of even more preferably from 1 to 20% by weight, and especially preferably from 5 to 20% by weight, from the viewpoint of satisfying both high removability and rinsability for a liquid crystal compound.

In addition, in the cleaning of a copper plate, the proportion of the hydrocarbon to a total amount of the alkyl glycoside, the glyceryl ether, and the hydrocarbon compound is preferably from 3 to 50% by weight, more preferably from 5 to 50% by weight, even more preferably from 7.5 to 50% by weight, still even more preferably from 7.5 to 45% by weight, and still even more preferably from 10 to 45% by weight, from the viewpoint of stabilizing the dispersion of the hydrocarbon compound and water, thereby satisfying both high cleanability and rinsability.

<<Preferred Combination>>

A preferred combination of the alkyl glycoside, the glyceryl ether, and the hydrocarbon compound in the present invention includes a combination in which the alkyl glycoside is a decyl polyglucoside and/or a dodecyl polyglucoside, the glyceryl ether is 2-ethylhexyl glyceryl ether and/or hexyl glyceryl ether, and the hydrocarbon compound is at least one compound selected from the group consisting of decene, dodecene, tetradecene, decane, dodecane, and tetradecane.

<<Glycol Ether>>

It is preferable that the cleaning agent composition of the present invention contains a glycol ether, from the viewpoint of lowering the viscosity of a cleaning liquid, suppressing foamability during cleaning, and further reducing the loads on wastewater upon rinsing immediately after cleaning (hereinafter referred to as “pre-rinsing”). In a case where the cleaning agent composition of the present invention contains a glycol ether, especially when an oil-water separation method as shown hereinbelow is employed, it is preferable to use the composition without dilution, from the viewpoint of providing an excellent separation property. The glycol ether usable in the present invention includes ethylene glycol monoalkyl(1 to 12 carbon atoms) ethers, diethylene glycol monoalkyl(1 to 12 carbon atoms) ethers, triethylene glycol monoalkyl(1 to 12 carbon atoms) ethers, monoalkyl(1 to 12 carbon atoms) ethers of benzyl glycol, benzyl diglycol, phenyl glycol, propylene glycol, or dipropylene glycol, monoalkyl(1 to 12 carbon atoms) ethers of dialkyl glycols(2 to 12 carbon atoms). Among them, ethylene glycol monohexyl ether, ethylene glycol mono(2-ethylhexyl)ether, diethylene glycol monobutyl ether, diethylene glycol monohexyl ether, diethylene glycol mono(2-ethylhexyl)ether, triethylene glycol monobutyl ether, dipropylene glycol monobutyl ether, diethylene glycol dimethyl ether, and diethylene glycol dibutyl ether are preferable. Diethylene glycol monohexyl ether, diethylene glycol mono(2-ethylhexyl)ether, dipropylene glycol monobutyl ether, and diethylene glycol dibutyl ether are especially preferable, from the viewpoint of carrying out a cleaning process for reducing loads on the wastewater of a rinsing liquid as described in JP-B-2539284 (hereinafter referred to as “oil-water separation method”). These glycol ethers may be used alone or in admixture of two or more kinds.

In the cleaning of a silicone-treated tool, the glycol ether is contained in an amount of preferably from 10 to 30 parts by weight, more preferably from 12 to 28 parts by weight, even more preferably from 15 to 25 parts by weight, and still even more preferably from 18 to 21 parts by weight, based on 100 parts by weight of the content of a total of the alkyl glycoside, the glyceryl ether, and the hydrocarbon compound, from the viewpoint of adjusting a cloud point of the cleaning agent composition to 30° C. or more, thereby cleaning at a high temperature, and carrying out an oil-water separation method.

In the cleaning of a liquid crystal-treated tool, the glycol ether is contained in an amount of preferably from 0.01 to 40% by weight, more preferably from 0.01 to 30% by weight, even more preferably from 0.1 to 25% by weight, especially preferably from 0.5 to 20% by weight, and most preferably from 0.5 to 15% by weight, of the cleaning agent composition, from the viewpoint of adjusting a cloud point of the cleaning agent composition to 30° C. or more, thereby cleaning at a high temperature, and carrying out an oil-water separation method.

In the cleaning of a copper plate, the glycol ether is contained in an amount of preferably from 1 to 70 parts by weight, more preferably from 5 to 50 parts by weight, even more preferably from 15 to 40 parts by weight, and still even more preferably from 15 to 36 parts by weight, based on 100 parts by weight of the content of a total of the alkyl glycoside, the glyceryl ether, and the hydrocarbon, from the viewpoint of adjusting a cloud point of the cleaning agent composition to 30° C. or more, thereby cleaning at a high temperature, and carrying out an oil-water separation method.

<<Organic Acid and Inorganic Acid>>

In the cleaning of a silicone-treated tool, it is preferable that the cleaning agent composition of the present invention further contains an organic acid and/or an inorganic acid, from the viewpoint of even more improving the removability of an amino-modified silicone. The organic acid includes hydroxy-acids such as glycolic acid, malic acid, citric acid, tartaric acid, and lactic acid, and the like, among which glycolic acid is preferable. The inorganic acid includes boric acid, silicic acid, and the like. These organic acids and inorganic acids may be used alone or in admixture of two or more kinds.

In a case where the organic acid or the inorganic acid is used alone, each acid is contained in an amount of preferably from 0.1 to 1 part by weight, more preferably from 0.1 to 0.5 parts by weight, even more preferably from 0.15 to 0.45 parts by weight, and still even more preferably from 0.2 to 0.4 parts by weight, based on 100 parts by weight of the content of a total of the alkyl glycoside, the glyceryl ether, and the hydrocarbon compound, from the viewpoint of maintaining high solubility and removability. In addition, in a case where the organic acids or inorganic acids are used in two or more kinds, the acids are contained in a total amount of preferably from 0.1 to 1 part by weight, more preferably from 0.1 to 0.5 parts by weight, even more preferably from 0.15 to 0.45 parts by weight, and still even more preferably from 0.2 to 0.4 parts by weight, based on 100 parts by weight of the content of a total of the alkyl glycoside, the glyceryl ether, and the hydrocarbon compound, from the viewpoint of maintaining high solubility and removability.

<<Inorganic Acid Salt and Benzotriazole Derivative>>

In the cleaning of a copper plate, the cleaning agent composition of the present invention can contain an inorganic acid salt and/or a benzotriazole derivative.

The inorganic acid salt usable in the present invention includes silicic acid salts such as sodium orthosilicate, sodium metasilicate, sodium sesquisilicate (for example, No. 1 Sodium Silicate, No. 2 Sodium Silicate, and No. 3 Sodium Silicate); phosphoric acid salts such as sodium dihydrogenphosphate, disodium hydrogenphosphate, trisodium phosphate, sodium pyrophosphate, sodium tripolyphosphate, and sodium hexametaphosphate; carbonic acid salts such as disodium carbonate, sodium hydrogencarbonate, dipotassium carbonate, and potassium hydrogencarbonate; boric acid salts such as sodium borate; and the like, among which sodium orthosilicate, sodium metasilicate, and disodium carbonate are preferable. These inorganic acid salts may be used alone or in admixture of two or more kinds.

The inorganic acid salt is contained in an amount of preferably from 0.1 to 3 parts by weight, more preferably from 0.3 to 2 parts by weight, even more preferably from 0.5 to 1.5 parts by weight, and still even more preferably from 0.7 to 1 part by weight, based on 100 parts by weight of the content of a total of the alkyl glycoside, the glyceryl ether, and the hydrocarbon, from the viewpoint of cleanability and economic advantage.

<<Benzotriazole Derivative>>

The benzotriazole derivative usable in the present invention includes a compound represented by the general formula:

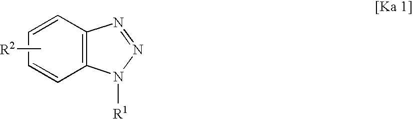

wherein R¹ is one member selected from the group consisting of —H, —CH₂OH, —CH(COOH)CH₂COOH, —CH₂—CH(OH)—CH₂OH, —CH₂CH(COOH)CH₂COOH, —CH₂N(C₂H₄OH)₂, and —CH₂NH—CONH₂; and R² is —H or —COOH.

Among them, a benzotriazole derivative in which R¹ is —CH₂CH(COOH)CH₂COOH or —CH₂NH—CONH₂, and R² is —H in the general formula is preferable, from the viewpoint of further improving solubility to a cleaning liquid and a rustproof effect to copper.

Specific examples of the benzotriazole derivative represented by the above-mentioned general formula include 1,2,3-benzotriazole, 1-(1′,2′-dicarboxyethyl)benzotriazole, 1-[N,N′-bis(hydroxyethyl)aminomethyl]tolyltriazole, and the like.

The benzotriazole derivative is contained in an amount of preferably from 0.01 to 0.3 parts by weight, more preferably from 0.03 to 0.2 parts by weight, even more preferably from 0.05 to 0.15 parts by weight, and still even more preferably from 0.07 to 0.1 parts by weight, based on 100 parts by weight of the content of a total of the alkyl glycoside, the glyceryl ether, and the hydrocarbon, from the viewpoint of cleanability and economic advantage.

<<Other Components>>

In the cleaning of a silicone-treated tool, the cleaning agent composition of the present invention may further contain an alkalizing agent, a defoaming agent, other surfactants, a preservative, a rustproof agent, an oil-water separation adjuster such as 1-octanol, or the like, which is ordinarily used in a cleaning agent composition, in an amount within the range so as not to impair the effects of the present invention. In addition, in the cleaning of a liquid crystal-treated tool, the cleaning agent composition of the present invention may optionally be used together with other surfactants, a preservative, a rustproof agent, a defoaming agent such as a silicone, an oil-water separation adjusting agent such as 1-octanol, or the like, which is ordinarily used in a cleaning agent composition, in an amount within the range so as not to impair the effects of the present invention.

<<Water>>

The water usable in the present invention is not particularly limited, and includes ion-exchanged water, pure water, deionized water, and the like, and ion-exchanged water is preferable. In the application of cleaning precision parts, pure water is preferable, and in the application of cleaning a jig or tool, a metal, glass, a ceramic or a plastic, ion-exchanged water is preferable. Here, pure water refers to water obtained by allowing tap water to pass through an activated charcoal, subjecting the water to ion-exchanging, further distilling the ion-exchanged water, and optionally allowing the distilled water to pass through a given filter. The content of water may be appropriately set depending upon the use embodiment of the cleaning agent composition of the present invention.

In the cleaning of a silicone-treated tool, the amount of water is adjusted as follows.

### EMBODIMENT 1

For example, in a case where a cleaning agent composition of the present invention is diluted with an aqueous medium such as water to be used in the cleaning of a silicone-treated tool, water is contained in an amount of preferably from 50 to 98% by weight, more preferably from 60 to 98% by weight, even more preferably from 70 to 98% by weight, and still even more preferably from 80 to 98% by weight, of the cleaning agent composition, from the viewpoint of preventing the cleaning agent composition from being ignited, and from the viewpoint of economic advantage.

### EMBODIMENT 2

Alternatively, in a case where a cleaning agent composition of the present invention is directly used for cleaning a silicone-treated tool, the water is contained in an amount of preferably from 20 to 90% by weight, more preferably from 40 to 80% by weight, even more preferably from 45 to 75% by weight, and still even more preferably from 50 to 70% by weight, of the cleaning agent composition, from the viewpoint of reducing the loads of wastewater upon use.

In the cleaning of a liquid crystal-treated tool, the water is contained in an amount of preferably from 5 to 95% by weight, more preferably from 10 to 95% by weight, even more preferably from 30 to 90% by weight, especially preferably from 50 to 90% by weight, and most preferably from 60 to 90% by weight, of the cleaning agent composition, from the viewpoint of preventing the cleaning agent composition from being ignited, and from the viewpoint of increasing rinsability.

In the cleaning of a copper plate, the amount of water is adjusted as follows.

### EMBODIMENT 1

For example, in a case where a cleaning agent composition of the present invention is diluted with an aqueous medium such as water to be used in the cleaning of a copper plate, water is contained in an amount of preferably from 20 to 90% by weight, more preferably from 40 to 80% by weight, even more preferably from 45 to 75% by weight, and still even more preferably from 50 to 70% by weight, of the cleaning agent composition, from the viewpoint of preventing the cleaning agent composition from being ignited, and from the viewpoint of economic advantage.

### EMBODIMENT 2

Alternatively, in a case where a cleaning agent composition of the present invention is directly used for cleaning a copper plate, the water is contained in an amount of preferably from 50 to 99.9% by weight, more preferably from 80 to 99.9% by weight, even more preferably from 85 to 99.8% by weight, and still even more preferably from 86 to 99.7% by weight, of the cleaning agent composition, from the viewpoint of reducing the loads of wastewater upon use.

<<pH>>

In the cleaning of a copper plate, the pH of the cleaning agent composition of the present invention can be properly set depending upon an object to be cleaned. Among them, in a case where a cleaning agent composition of the present invention is used for cleaning a rolling oil or the like deposited on the surface of a copper plate, the pH is preferably from 4 to 12, more preferably from 7 to 12, and even more preferably from 9 to 12, from the viewpoint of improving the cleanability of the surface of a copper plate after cleaning. The pH can be adjusted with, for example, a pH adjusting agent such as an inorganic acid such as hydrochloric acid or nitric acid, an organic acid such as acetic acid or citric acid, an inorganic alkali such as sodium hydroxide or potassium hydroxide, or an organic amine such as monoethanolamine or diethanolamine.

<<Preparation Method>>

The cleaning agent composition of the present invention having the above constitution can be produced by mixing the above components and other components and the like according to a conventional method. For example, the cleaning agent composition can be produced by mixing the above alkyl glycoside, the above glyceryl ether, the above hydrocarbon compound, and the above glycol ether while stirring, further optionally mixing other components therewith, and finally adding water thereto.

<<Applications>>

The cleaning agent composition of the present invention can be applied to cleaning a silicone-treated tool. Also, the cleaning agent composition of the present invention can be applied to cleaning according to an oil-water separation method in which the loads of wastewater of a rinsing liquid are reduced. By applying the cleaning agent composition of the present invention to the cleaning as mentioned above, effects such as shortening of the cleaning time and conservation of energy are exhibited. Therefore, the present invention also relates to a cleaning process for a silicone-treated tool with the above cleaning agent composition.

The cleaning agent composition of the present invention can be applied to cleaning a liquid crystal-treated tool. By applying the cleaning agent composition of the present invention to cleaning a liquid crystal-treated tool, effects such as shortening of the cleaning time and conservation of energy are exhibited. Therefore, the present invention also relates to a cleaning process for a liquid crystal-treated tool with the above cleaning agent composition.

The cleaning agent composition of the present invention can be applied to cleaning a copper plate. For example, the cleaning agent composition of the present invention can be applied to cleaning a copper plate for precision parts, jigs or tools, and the like. In addition, the cleaning agent composition of the present invention can be preferably applied to cleaning a copper plate at a low temperature, their effects can be exhibited in especially continuous cleaning of copper plates, specifically continuous cleaning of copper plates in ironworks, such as immersion cleaning, spray cleaning, brush cleaning, or electrolytic cleaning, and specifically in immersion cleaning, shower cleaning, immersion ultrasonic cleaning or the like.

A specific example of the cleaning process for a conventional liquid crystal-treated tool with methylene chloride shall be briefly explained herein. For example, a 100 L formulation tank made of stainless steel (SUS) after mixing the liquid crystal is charged with 80 L of methylene chloride, and the mixture is stirred for 30 minutes at an ambient temperature, and discarded as a waste liquid. The above procedures are repeated three to five times, and thereafter the formulation tank is charged with 50 to 80 L of a water-soluble solvent (for example, acetone, or the like), and the mixture is stirred for 30 minutes at an ambient temperature, and discarded as a waste liquid. Subsequently, the formulation tank is charged with 80 L of pure water, and the mixture is stirred at 60° C. for 30 minutes, and discarded as a waste liquid. This procedure was repeated 10 times, whereby the desired cleanliness is obtained.

<<Cleaning Process for Silicone-Treated Tool>>

The cleaning process of the present invention includes the step of cleaning a silicone-treated tool with the above cleaning agent composition (hereinafter simply referred to a cleaning step in some cases). It is preferable that the cleaning process further includes a rinsing step for rinsing away a silicone or a mixture thereof, solubilized in the components of the cleaning agent composition and/or components of the cleaning agent composition that remain on the silicone-treated tool, and a drying step.

In the above cleaning step, the cleaning agent composition of the present invention may be directly used as it is in cleaning a silicone-treated tool as mentioned above. The cleaning agent composition of the present invention may be diluted with an aqueous medium such as water, and preferably water, to an amount of preferably from 2 to 20 folds, more preferably from 3 to 15 folds, and even more preferably from 3 to 10 folds, and used in the cleaning of a silicone-treated tool, from the viewpoint of reducing the loads of wastewater.

The cleaning temperature in the cleaning step is preferably 40° C. or more, from the viewpoint of exhibiting sufficient solubility and removability for a silicone or a mixture thereof that is deposited on the silicone-treated tool. The cleaning temperature is more preferably 60° C. or more, from the viewpoint of improving solubility and removability due to the reduction in the viscosity of the silicone or a mixture thereof. In addition, the cleaning temperature is preferably 90° C. or less, and more preferably 80° C. or less, from the viewpoint of suppressing evaporation of water.

Although the cleaning time cannot be unconditionally stated because the cleaning time differs depending upon the kinds of the silicone-treated tool to be cleaned and the amount and the kinds of the deposited silicone and a mixture thereof, the silicone and a mixture thereof are sufficiently cleaned off from the silicone-treated tool in a cleaning time of from 30 to 60 minutes.

A cleaning means include various known cleaning means such as an immersion method, a ultrasonic cleaning method, an immersion and oscillation method, a spraying method, an electrolytic cleaning, and a hand rubbing method. The silicone-treated tool can be cleaned with these means alone or in an appropriate combination depending upon the kinds of the silicone-treated tool.

For example, in a case where a silicone-treated tool is a silicone formulation facility, the silicone formulation facility is cleaned by charging the silicone formulation facility with an undiluted solution of the above cleaning agent composition, or a diluted solution prepared by diluting the above cleaning agent composition with water in an appropriate fold, and operating an agitator attached to the silicone formulation facility. Here, the agitation rate of the agitator device may be at a rate equal to or greater than that at which turbulence is generated within the facility in the meaning of increasing a cleaning effect.

On the other hand, in a case where the silicone-treated tool is a jig or tool, the jig or tool is cleaned by the steps of immersing a jig or tool in a cleaning vessel filled with an undiluted solution of the above cleaning agent composition, or a diluted solution prepared by diluting the cleaning agent composition with water in an appropriate fold, and subjecting the jig or tool to various known cleaning processes, such as a ultrasonic cleaning method, an immersion and oscillation method, and a spraying method in liquid or gas, alone or in a combination of these methods.

The rinsing step is carried out in order to discard the cleaning agent composition after the termination of the cleaning step to thereby remove from the silicone formulation facility a silicone and a mixture thereof solubilized in the components of the cleaning agent composition and/or the components of the cleaning agent composition, that remain in the silicone formulation facility. The drying step is carried out in order to dry the water remaining on the silicone-treated tool after the termination of the rinsing step.

<<Cleaning Process for Liquid Crystal-Treated Tool>>

Next, a specific example of the cleaning process for a liquid crystal-treated tool with the cleaning agent composition of the present invention shall be briefly explained herein. For example, a 100 L formulation tank made of stainless steel after mixing the liquid crystal is charged with 80 L of a cleaning agent composition, the temperature is raised to 60° C., and the content is stirred for 30 minutes, and discharged as a waste liquid. The above procedures are repeated twice, and thereafter the formulation tank is charged with 80 L of pure water, and the mixture is stirred at 60° C. for 30 minutes, and discarded as a waste liquid. The procedures are repeated five times, whereby the desired cleanliness is obtained.

As mentioned above, the cleaning process for a liquid crystal-treated tool with a cleaning agent composition of the present invention can shorten the cleaning time because the number of steps can be reduced as compared to those of conventional cleaning processes.

The cleaning process of the present invention includes the step of cleaning a liquid crystal-treated tool with the above cleaning agent composition (hereinafter simply referred to a cleaning step in some cases). It is preferable that the cleaning process further includes a rinsing step for rinsing away the components of the cleaning agent composition that are deposited on the liquid crystal-treated tool, and a drying step.

In the above cleaning step, the above cleaning agent composition may be used in the form of undiluted solution. The cleaning agent composition may be diluted with water to an amount of preferably from 2 to 6 folds, and more preferably from 3 to 5 folds, and used, from the viewpoint of reducing the loads of wastewater.

The cleaning temperature in the cleaning step is preferably 40° C. or more, from the viewpoint of exhibiting sufficient removability for a liquid crystal compound and other deposition that are deposited on the liquid crystal-treated tool. The cleaning temperature is more preferably 50° C. or more, even more preferably 60° C. or more, from the viewpoint of improving removability due to the reduction in the viscosity of the liquid crystal compound. In addition, the cleaning temperature is preferably 90° C. or less, and more preferably 80° C. or less, from the viewpoint of suppressing evaporation of water.

Although the cleaning time cannot be unconditionally stated because the cleaning time differs depending upon the kinds of the liquid crystal-treated tool to be cleaned and the amount and the kinds of the deposited liquid crystal compound, the liquid crystal compound is sufficiently cleaned off from the liquid crystal-treated tool in a cleaning time of from 30 to 60 minutes.

A cleaning means include various known cleaning means such as an immersion method, a ultrasonic cleaning method, an immersion and oscillation method, a spraying method, an electrolytic cleaning, and a hand rubbing method. The liquid crystal-treated tool can be cleaned with these means alone or in an appropriate combination depending upon the kinds of the liquid crystal-treated tool.

For example, in a case where a liquid crystal-treated tool is a liquid crystal formulation tank, the liquid crystal formulation tank is cleaned by charging the liquid crystal formulation tank with an undiluted solution of the above cleaning agent composition, or a diluted solution prepared by diluting the above cleaning agent composition with water in an appropriate fold, and operating an agitator attached to the liquid crystal formulation tank. Here, the agitation rate of the agitator device may be at a rate equal to or greater that at which turbulence is generated inside the facility in the meaning of increasing the cleaning effect.

On the other hand, in a case where the liquid crystal-treated tool is a jig or tool, the jig or tool is cleaned by the steps of immersing a jig or tool in a cleaning vessel filled with an undiluted solution of the above cleaning agent composition, or a diluted solution prepared by diluting the cleaning agent composition with water in an appropriate fold, and subjecting the jig or tool to various known cleaning processes, such as a ultrasonic cleaning method, an immersion and oscillation method, and a spraying method in liquid or gas, alone or in a combination of these methods.

The rinsing step is carried out in order to discard the cleaning agent composition after the termination of the cleaning step to thereby remove from the liquid crystal formulation tank a liquid crystal compound solubilized in the components of the cleaning agent composition and/or the components of the cleaning agent composition that remain in the liquid crystal formulation tank.

In the rinsing step, it is preferable to use water, from the viewpoint of reducing the loads to the environment.

The rinsing temperature in the rinsing step is preferably 30° C. or more, more preferably 40° C. or more, and even more preferably 50° C. or more, from the viewpoint of facilitating the dispersion of the liquid crystal compound solubilized in the cleaning agent composition and/or the components of the cleaning agent composition in water, and the rinsing temperature is preferably 90° C. or less, and more preferably 80° C. or less, from the viewpoint of conservation of energy.

The rinsing time and the number of rinsing cannot be unconditionally stated because they may differ depending upon the amount of the liquid crystal compound solubilized in the cleaning agent composition and/or the components of the cleaning agent composition that remain on the liquid crystal-treated tool. The residual substances can be sufficiently removed by rinsing for 30 to 60 minutes for four to six times in the liquid crystal formulation tank, or rinsing for 5 to 10 minutes for four to six times in the jig or tool.

As a rinsing means, the same means as those in the cleaning means can be employed.

For example, in a case where a liquid crystal-treated tool is a liquid crystal formulation tank, the rinsing step can be carried out in the same manner as in the above cleaning step, except that water is used in place of the cleaning agent composition. On the other hand, also in a case where a liquid crystal-treated tool is a jig or tool, the rinsing step can be carried out in the same manner as in the above cleaning step, except that water is used in place of the cleaning agent composition.

The drying temperature and time in the drying step are not particularly limited, so long as the water remaining in the liquid crystal-treated tool can be dried. Drying is carried out usually at 40° to 110° C. for 0.1 to 1 hour.

The reasons why the desired cleanliness is obtained in the cleaning agent composition of the present invention with smaller number of cleaning and rinsing, as compared to those of a conventional solvent such as methylene chloride are supposedly as follows.

A solvent dissolves a liquid crystal remaining in a mixing tank, and a certain amount of a liquid crystal solution almost always remains on the tank surface during discarding as a waste liquid, and the amount remaining depending upon an amount of an introduced solvent. Even if a fresh solvent is introduced to the remaining liquid crystal to dissolve, a liquid crystal solution having a lower concentration yet remains during the discarding as a waste liquid, so that the liquid crystal cannot be completely removed. Therefore, in order to obtain a given level of cleanliness, a plural times of cleaning are necessitated, and especially in a case where a high level of cleanliness is in demand, the number of cleaning dramatically increases.

On the other hand, the solution structure in the cleaning agent composition of the present invention is supposedly so-called a bi-continuous structure, containing a continuous phase of an aqueous phase and an oil phase, and the cleaning and rinsing mechanisms are supposedly as follows.

The cleaning is accomplished by contacting a continuous phase containing a hydrocarbon compound in the cleaning agent composition of the present invention with a liquid crystal to dissolve. Concurrently with the incorporation of the liquid crystal into the hydrocarbon compound, an aqueous phase penetrates between an oil phase and hydrophilic glass, or surfaces of metals, to be contacted therewith. The surface once wetted with the aqueous phase is less likely to be wetted by an oil phase containing a liquid crystal, so that it is considered that the re-deposition of the liquid crystal is hardly generated. During the course of cleaning, the liquid crystals are almost entirely incorporated into the oil phase, the majority of the tank surface becomes a hydrophilic surface, so that it is considered to be in a wet state by the aqueous phase. During the discarding of a waste liquid, although almost all the liquid crystals are discharged in a state dissolved in the oil phase, a part of the cleaning liquid remains on the tank wall surface, so that the liquid crystals remain in the oil phase of this cleaning liquid.

However, when water for rinsing is subsequently added, the aqueous phase portion of the cleaning liquid is diluted with the rinsing water, so that the volume ratio of the aqueous phase is dramatically increased as compared to that of the oil phase, so that the oil phase portion containing the liquid crystals cannot maintain a continuous phase. Consequently, it is considered that the solution structure undergoes changes to a stable O/W microemulsion. In this microemulsion structure, since an oil phase stably exists in an aqueous phase, a re-deposition cannot further take place. On the surface of the wall surface, not only the liquid crystals but also even the oil phase would not be able to remain, so that a given level of cleanliness can be obtained with reduced number of rinsing.

In addition, the cleaning agent composition of the present invention can be used in cleaning according to an oil-water separation method in which the loads of wastewater from a rinsing liquid are reduced.

Further, the cleaning agent composition of the present invention can be used not only for the liquid crystal-treated tool, but also in the field that necessitates precision cleaning such as a perfume or a colorant.

<<Cleaning Process for Copper Plate>>

The cleaning process of the present invention includes the step of cleaning a copper plate with the above cleaning agent composition (hereinafter simply referred to a cleaning step in some cases). It is preferable that the cleaning process further includes a rinsing step for rinsing away stains solubilized in the components of the cleaning agent composition and/or components of the cleaning agent composition that remain on the copper plate, and a drying step.

In the above cleaning step, as mentioned above, the cleaning agent composition of the present invention may be directly used as it is in cleaning a copper plate. The cleaning agent composition of the present invention may be diluted with an aqueous medium such as water, and preferably water, to an amount of preferably from 1 to 10 folds, more preferably from 2 to 8 folds, and even more preferably from 3 to 6 folds, and used in the cleaning of a copper plate, from the viewpoint of reducing the loads of wastewater. In addition, in a case where the cleaning agent composition of the present invention is used in cleaning a copper plate, the cleaning agent composition may be diluted with an aqueous medium such as water, and preferably water, to an amount of preferably from 5 to 50 folds, more preferably from 10 to 30 folds, and even more preferably from 15 to 20 folds, and used in the cleaning of a copper plate.

In addition, in the cleaning steps, it is preferable to use a cleaning agent composition of the present invention of which pH change according to the following standard test is 1 or less, from the viewpoint of obtaining stable solubility and removability, and it is more preferable to use a cleaning agent composition of which pH change is 0.5 or less. A calibration method for a pH in a standard test is based on JIS Z8802.

### <Standard Test>

### (1) Pure water (pH=6-7, 1 μS/cm or less) is added to a cleaning agent composition to prepare a 10% by weight aqueous solution, and a pH at 25° C. of this aqueous solution is determined.

(2) One-hundred milliliters of the aqueous solution prepared in item (1) is kept under a tight seal in a 1000 mL glass container at 60° C. for 21 days. Here, during the keeping, in every 24 hours, the cap is taken off, the glass container is allowed to stand at 60° C. for 1 minute and then recapped, and the glass container is shaken five times.

### (3) After the termination of keeping in item (2), a pH at 25° C. of the aqueous solution after being kept is determined.

### (4) An absolute value of a difference of a pH determined in item (1) and a pH determined in (3) is obtained, and the value is defined as a pH change.

The cleaning temperature in the cleaning step is preferably 40° C. or more, and more preferably 60° C. or more, from the viewpoint of exhibiting sufficient solubility and removability for stains that are deposited on the rigid surface. In addition, the cleaning temperature is preferably 90° C. or less, and more preferably 80° C. or less, from the viewpoint of suppressing evaporation of water.

Although the cleaning time cannot be unconditionally stated because the cleaning time differs depending upon the kinds of the rigid materials to be cleaned, and the amount and the kinds of the deposited stains, the stains are sufficiently cleaned off from the rigid surface in a cleaning time of from 30 to 60 minutes.

A cleaning means include various known cleaning means such as an immersion method, a ultrasonic cleaning method, an immersion and oscillation method, a spraying method, an electrolytic cleaning, and a hand rubbing method. The rigid surface can be cleaned with these means alone or in an appropriate combination depending upon the kinds of the rigid materials.

The rinsing step is carried out in order to discard the cleaning agent composition as waste after the termination of the cleaning step to thereby remove from the rigid surface stains solubilized in the components of the cleaning agent composition and/or the components of the cleaning agent composition that remain on the rigid surface. The drying step is carried out in order to dry the water remaining on the rigid surface after the termination of the rinsing step.

Also, the cleaning agent composition of the present invention can be applied to cleaning according to an oil-water separation method in which the loads of wastewater of a rinsing liquid are reduced.

The solution structure in the composition of the present invention is supposedly so-called a bi-continuous structure, containing a continuous phase of an aqueous phase and an oil phase, and the cleaning and rinsing mechanisms are supposedly as follows.

The cleaning is accomplished by contacting a continuous phase containing a hydrocarbon compound component in the cleaning agent composition of the present invention with a silicone and a mixture thereof, a liquid crystal and a mixture thereof, an oil component, a flux, or the like, to dissolve. Concurrently with the incorporation of the silicone and a mixture thereof into the hydrocarbon compound component, an aqueous phase penetrates between an oil phase and hydrophilic surfaces of metals, to be contacted therewith. The surface once wetted with the aqueous phase is less likely to be wetted by the oil phase containing a silicone and a mixture thereof, so that it is considered that the re-deposition of the silicone and a mixture thereof is hardly generated. During the course of cleaning, since the silicone and a mixture thereof are almost entirely incorporated into the oil phase, the majority of the surface of the facility or the like is a hydrophilic surface, so that it is considered to be in a wet state by the aqueous phase. During the discarding of a waste liquid, although almost all the silicone and a mixture thereof are discharged in a state dissolved in the oil phase, a part of the cleaning liquid remains on the wall surface of the facility or the like, so that the silicone and a mixture thereof remain in the oil phase of this cleaning liquid.

However, when water for rinsing is subsequently added, the aqueous phase portion of the cleaning liquid is diluted with the rinsing water, so that the volume ratio of the aqueous phase is dramatically increased as compared to that of the oil phase, so that the oil phase portion containing the silicone and a mixture thereof cannot maintain a continuous phase. Consequently, it is considered that the solution structure undergoes changes to a stable O/W microemulsion. In this microemulsion structure, since an oil phase stably exists in an aqueous phase, a further re-deposition cannot take place. On the surface of the wall surface, not only the silicone and a mixture thereof but also even the oil phase would not be able to remain, so that a given level of cleanliness can be obtained with reduced number of rinsing.

### EXAMPLES

### Example I

### Cleanability of Cup Made of SUS Steel

1. Preparation of Testing Cup

The amount 1.5 g of a modified silicone having the following composition was applied to a 500 ml cup made of SUS steel, to provide a testing cup.

TABLE 1
<Composition of Modified Silicone>

| Composition | | % by wt. |
|---|---|---|
| Methyl | A mixture of components having 3 to 650 | 36.2 |
| Polysiloxane | repeating units of a dimethyl siloxane backbone | |
| | A mixture of components having 2500 to 2700 | 13.8 |
| | repeating units of a dimethyl siloxane backbone | |
| Amino- | XF-42-B1989 (manufactured by GE-Toshiba | 50 |
| Modified | Silicone) | |
| Silicone | | |

2. Preparation of Cleaning Agent Composition

Each component was added and mixed so as to have the composition as shown in Table 2 to prepare each of the cleaning agent compositions of Examples 1 to 5 and Comparative Examples 1 and 2. Here, the composition in the table is all expressed in % by weight.

A cleaning agent composition of Example 1 prepared above was diluted with pure water in 3-fold and 10-fold, to prepare each of the cleaning agent compositions of Examples 2 and 3. In addition, a cleaning agent composition composed of an alkyl glycoside 26.7% by weight, 2-ethylhexyl glyceryl ether 6.7% by weight, 1-dodecene 16.6% by weight, glycolic acid 0.15% by weight, and pure water 49.85% by weight was prepared, and further diluted with pure water in 3-fold, to prepare a cleaning agent composition of Example 4. Here, the composition of each component in the cleaning agent composition after the dilution is as shown in Table 2.

3. Cleaning Test

A testing cup prepared in 1. was charged with 150 g of a cleaning agent composition prepared in 2, and the cleaning agent composition was stirred at 60° C. for 30 minutes, and thereafter discarded. Next, the cup after being cleaned was charged with 150 g of ion-exchanged water at 60° C., the mixture was stirred for 30 minutes, and the rinsing liquid was then discarded. The rinsing procedures were carried out three times, and drying was carried out with a hot air dryer at 100° C. for 40 minutes, to provide an observation cup.

[Cleanability]

Silicone remaining on the observation cup was weighed to evaluate removability. The results are shown in Table 2. Here, the weight of the remaining silicone was obtained from the weight of the cup before the application of silicone, the weight of the cup of the testing cup, and the weight of the observation cup.

TABLE 2

| Composition | Ex. | | | | | Comp. Ex. | |
|---|---|---|---|---|---|---|---|
| (% by weight) | 1 | 2 | 3 | 4 | 5 | 1 | 2 |
| Alkyl Polyglucoside*¹ | 26.7 | 8.90*² | 2.67*² | 8.90*² | 16.5 | — | — |
| 2-Ethylhexyl Glyceryl Ether | 6.7 | 2.23*² | 0.67*² | 2.23*² | 4 | — | — |
| 1-Dodecene | 16.6 | 5.53*² | 1.66*² | 5.53*² | 12 | — | — |
| Diethylene Glycol | — | — | — | — | 5.9 | — | — |
| Monohexyl Ether | | | | | | | |
| Triethylene Glycol | — | — | — | — | 2 | — | — |
| Monobutyl Ether | | | | | | | |
| Glycolic Acid | — | — | — | 0.05*² | — | — | — |
| 1-Octanol | — | — | — | — | 0.1 | — | — |
| Sodium | — | — | — | — | — | 15 | 5 |
| Dodecylbenzenesulfonate | | | | | | | |
| Pure Water | 50.0 | 83.34*² | 95.0*² | 83.29*² | 59.5 | 85 | 95 |
| Residual Silicone (%) | 1.3 | 2.6*³ | 4.9*³ | 0.1*³ | 1.5 | 39.5 | 53.7 |

*¹In the general formula (1), R¹ = a linear alkyl group having an average number of carbon atoms of 11.3, x = 0, y = 1.3, G = glucose residue.
*²Showing a composition of the composition after dilution.
*³The results using the composition after the dilution.

It can be seen from the results of Table 2 that the cleaning agent compositions of Examples 1 to 5 clearly have excellent solubility and removability for silicone as compared to those of the cleaning agent compositions of Comparative Examples 1 and 2.

### Example II

### Examples 1 and 2 and Comparative Example 1

Each component was added and mixed so as to provide a composition as shown in Table 3, to prepare each of the cleaning agent compositions of Examples 1 and 2 and Comparative Example 1.

TABLE 3

| Cleaning Agent Composition | | | Comp. |
|---|---|---|---|
| (% by weight) | Ex. 1 | Ex. 2 | Ex. 1 |
| Alkyl Glycoside* | 8.9 | 16.5 | — |
| 2-Ethylhexyl Glyceryl Ether | 2.23 | 4 | — |
| 1-Dodecene | 5.53 | 12 | — |
| Water | 83.31 | 59.5 | — |
| Diethylene Glycol Monohexyl Ether | — | 5.9 | — |
| Triethylene Glycol Monobutyl Ether | — | 2 | — |
| 1-Octanol | — | 0.1 | — |
| Methylene Chloride | — | — | 100 |

*An alkyl glycoside represented by the formula R¹G_{1.3}, wherein R¹ is a linear alkyl group having an average number of carbon atoms of 11.3; and G is glucose residue.

### Test Example 1 Evaluation of Removability

The amount 1.5 g of liquid crystals for TFT were weighed in a 500 ml cup made of SUS steel, and 150 ml of a cleaning agent composition prepared in Example 1 or Comparative Example 1 was then placed into the cup. The mixture was stirred for 30 minutes at 60° C. or 25° C., respectively, and thereafter the cleaning agent composition was discarded. Next, the cup after cleaning was charged with 150 ml of ion-exchanged water, and stirred at 60° C. for 10 minutes, and thereafter the rinsing liquid was discarded. The rinsing procedures were carried out three times, and an organic content remaining in the cup after rinsing was determined. The results are shown in Table 4. Here, in the determination of the organic content, inside the cup after rinsing was washed away with 200 ml of a special-purpose solvent S-316 (manufactured by HORIBA, Ltd.), and the organic content dissolved in the solvent was determined with an oil content analyzer (OCMA-220, manufactured by HORIBA, Ltd.).

TABLE 4

| | | Comp. |
|---|---|---|
| | Ex. 1 | Ex. 1 |
| Organic Content (ppm) | 0.1 | 5.2 |

It can be seen from the results of Table 4 that the cleaning agent composition of Example 1 has clearly excellent removability for a liquid crystal compound as compared the cleaning agent composition of the comparative example.

### Test Example 2 Evaluation of Rinsability

The amount 0.5 g of liquid crystals for TFT were weighed in a 100 ml glass sample bottle, and 20 ml of a cleaning agent composition prepared in Example 1 or 2 or Comparative Example 1 was then placed into the cup. The mixture was kept thereat for 30 seconds and then cleaned with shaking 10 times, and the cleaning agent composition was discarded. Next, the sample bottle after cleaning was charged with 50 ml of ion-exchanged water, and rinsing was carried out with shaking 10 times, and thereafter the rinsing liquid was discarded. The rinsing procedures were carried out for once to four times (Rinsings 1 to 4), and an organic content remaining in the sample bottle after rinsing was determined. The results are shown in Table 5. Here, in the determination of the organic content, inside the bottle after rinsing was washed away with 100 ml of a special-purpose solvent S-316 (manufactured by HORIBA, Ltd.), and the organic content dissolved in the solvent was determined with an oil content analyzer (OCMA-220, manufactured by HORIBA, Ltd.). Here, the cleaning and the rinsing were carried out at a liquid temperature of 35° C.

TABLE 5

| Organic Content | | | Comp. |
|---|---|---|---|
| (ppm) | Ex. 1 | Ex. 2 | Ex. 1 |
| After Rinsing 1 | 0.33 | 0.25 | 0.52 |
| After Rinsing 2 | 0.02 | 0 | 0.41 |
| After Rinsing 3 | 0 | 0 | 0.33 |
| After Rinsing 4 | 0 | 0 | 0.20 |

It can be seen from the results shown in Table 5 that the cleaning agent compositions of Example 1 and 2 have dramatically reduced residual organic content in Rinsing 2 or later steps, as compared to that of the comparative example, whereby rinsing can be very conveniently carried out.

### Example III

### Cleanliness of Copper Plate Surface

1. Preparation of Testing Copper Plate

A copper plate having a deposited oil content of 70 mg/m², cold-pressed to a thickness of 1 mm, was cut into a size of 35 mm in length×120 mm in width to provide a testing copper plate.

2. Preparation of Cleaning Agent Composition

Each component was added and mixed so as to have a composition as shown in Table 6, to prepare each of the cleaning agent compositions of Examples 1 to 10 and Comparative Examples 1 to 4. Here, in the cleaning agent compositions of Examples 1 to 10, each component was added and mixed so as to have a composition as shown in Table 6 to prepare the composition, and thereafter diluted with ion-exchanged water in 4-fold, and the diluted solution was used in the subsequent 3. Cleaning Test.

3. Cleaning Test

A cleaning agent composition prepared in 2. was heated to 50° C., and a testing copper plate prepared in 1. was immersed in the cleaning agent composition, and subjected to ultrasonic cleaning (25 kHz, 600 W) for 30 seconds. Next, this copper plate was oscillated for 2 to 3 seconds in ion-exchanged water heated to 50° C. Thereafter, the testing copper plate was showered with tap water at 25° C. for 30 seconds, and then immersed in a 5% by weight aqueous citric acid solution at 25° C. for 10 seconds. Thereafter, the testing copper plate was further showered with tap water at 25° C. for 30 seconds, and then immersed in ion-exchanged water at 25° C. for 5 seconds. Finally, droplets remaining on the testing copper plate were blown away by air-blowing, and the testing copper plate was dried with a hot air dryer at 90° C. for 10 minutes to provide an observation sample.

[Cleanliness]

An observation sample was divided into 5 aliquot portions, a deposited oil content of the copper plate in each of the observed samples was determined with an oil content analyzer (“EMIA-111,” manufactured by HORIBA, Ltd.), and a found value was obtained as an average of five plates. Those having a value of less than 10 mg/m² were evaluated as being acceptable. The results are shown in Table 6.

[Generation of Rust or Oily Stain]

An observation sample was confirmed visually, and the generation of rust or an oily stain was confirmed, and evaluated in accordance with the following evaluation criteria. The results are shown in Table 6. Here, in both of items, those ranked as ⊚ or ◯ were considered as being acceptable.

### [Evaluation Criteria]

⊚: no generation of rust or oily stain;
◯: generation of rust or oily stain being slightly found;
Δ: generation of evident rust or oily stain being found at one spot; and

### X: generation of evident rust or oily stain being found at plural spots.

TABLE 6

| | |
|---|---|
| Ex. | Comp. Ex. |

| | 1 | 2 | 3 | 4 | 5 | 6 | 7 | 8 | 9 | 10 | 1 | 2 | 3 | 4 |
|---|---|---|---|---|---|---|---|---|---|---|---|---|---|---|
| Cleaning Agent Composition³⁾ | | | | | | | | | | | | | | |
| Alkyl Polyglucoside¹⁾ | 26.7 | 6.61 | 6.61 | 6.61 | 6.61 | 6.61 | 6.61 | 6.61 | 6.61 | 6.61 | 31.1 | 36.9 | — | — |
| 2-Ethylhexyl Glyceryl Ether | 6.7 | 1.66 | 1.66 | 1.66 | 1.66 | 1.66 | 1.66 | 1.66 | 1.66 | 1.66 | — | 13.1 | 14.4 | 3.57 |
| 1-Dodecene | 16.6 | 4.11 | 4.11 | 4.11 | 4.11 | 4.11 | 4.11 | 4.11 | 4.11 | 4.11 | 18.9 | — | 35.6 | 8.81 |
| Citric Acid | — | 0.1 | 0.1 | 0.1 | — | 0.1 | 0.1 | 0.1 | 0.1 | 0.1 | — | — | — | — |
| Sodium Hydroxide | — | 0.1 | 0.1 | 0.1 | 0.1 | 0.1 | — | 0.1 | 0.08 | — | — | — | — | — |
| 1,2-Propanediamine | — | — | — | — | — | — | 1.3 | — | — | — | — | — | — | — |
| 1-(1′,2′-Dicarboxyethyl)- | — | 0.01 | — | — | 0.01 | — | 0.01 | — | — | — | — | — | — | — |
| benzotriazole | | | | | | | | | | | | | | |
| 1,2,3-Benzotriazole | — | — | 0.01 | — | — | — | — | 0.05 | 0.05 | 0.05 | — | — | — | — |
| 1-[N,N′-Bis(hydroxyethyl)- | — | — | — | 0.01 | — | — | — | — | — | — | — | — | — | — |
| aminomethyl]tolyltriazole | | | | | | | | | | | | | | |
| Sodium Carbonate | — | — | — | — | 0.1 | — | — | — | — | — | — | — | — | — |
| Water | 50 | 87.41 | 87.41 | 87.41 | 87.41 | 87.42 | 86.21 | 87.37 | 87.39 | 87.47 | 50 | 50 | 50 | 87.62 |
| pH | 7.0 | 11.0 | 11.0 | 11.0 | 11.5 | 11.0 | 10.5 | 11.0 | 7.2 | 4.4 | 7.0 | 7.0 | 7.0 | 7.0 |
| Evaluation of Properties | | | | | | | | | | | | | | |
| Copper Plate Cleanliness (mg/m²) | 2.5 | 4.5²⁾ | 4.9²⁾ | 4.4²⁾ | 4.7²⁾ | 5.2²⁾ | 4.7²⁾ | — | — | — | 41.6 | 53.4 | 31.5 | 55.8 |
| Generation of Rust | ⊚ | ⊚²⁾ | ⊚²⁾ | ⊚²⁾ | ⊚²⁾ | ◯²⁾ | ⊚²⁾ | ⊚²⁾ | ⊚²⁾ | ⊚²⁾ | ⊚ | ⊚ | ⊚ | X |
| Generation of Oil Stain | ⊚ | ◯²⁾ | ◯²⁾ | ◯²⁾ | ◯²⁾ | ◯²⁾ | ◯²⁾ | ⊚²⁾ | ⊚-◯²⁾ | ◯²⁾ | X | X | Δ | X |

¹⁾In the general formula (1), R¹ = a linear alkyl group having an average number of carbon atoms of 11.3, x = 0, y = 1.3, and G = glucose residue.
²⁾Evaluation of a cleaning agent composition after dilution in 4-fold
³⁾% by weight

It can be seen from the results of Table 6 that all of the cleaning agent compositions obtained in Examples 1 to 7 have more excellent cleanliness, a rustproof effect, and prevention of stain of a copper plate than those obtained in Comparative Examples 1 to 4. In addition, it can be seen from the results of Examples 8 to 10 that the cleaning agent composition has a pH of preferably from 4 to 12, more preferably from 7 to 12, and even more preferably from 9 to 12, from the viewpoint of preventing the generation of an oily stain.

<<pH Stability>>

1. Preparation of Cleaning Agent Composition

Each component was added and mixed so as to have a composition as shown in Table 7, to prepare each of the cleaning agent compositions of Example 11 and Comparative Examples 5 and 6.

2. pH Stability Test

A pH change was determined in accordance with the above-mentioned standard test. The results are shown in Table 7.

TABLE 7

| Cleaning Agent Composition | | Comp. | Comp. |
|---|---|---|---|
| (% by weight) | Ex. 11 | Ex. 5 | Ex. 6 |
| Alkyl Polyglucoside¹⁾ | 26.7 | — | — |
| 2-Ethylhexyl Glyceryl Ether | 6.7 | — | — |
| 1-Dodecene | 16.6 | — | — |
| Polyoxyethylene(4) Oleyl Ether | — | — | 10 |
| Polyoxyethylene(4) Dodecyl Ether) | — | 10 | — |
| Diethylene Glycol Monobenzyl Ether | — | 40 | — |
| Diethylene Glycol Monobutyl Ether | — | — | 40 |
| Water | 50.0 | 50.0 | 50 |
| pH Before Keeping | 6.9 | 7.1 | 7.1 |
| pH After Keeping | 6.7 | 3.8 | 4.5 |
| pH Change | 0.2 | 3.3 | 2.6 |

¹⁾In the general formula (1), R¹ = a linear alkyl group having an average number of carbon atoms of 11.3, x = 0, y = 1.3, and G = glucose residue.

It can be seen from the results of Table 7 that the cleaning agent composition obtained in Example 11 has a pH change in accordance with the standard test of 1 or less, and that the cleaning agent compositions obtained in Comparative Examples 5 and 6 have a pH change exceeding 1. Therefore, it is considered that the cleaning agent composition of the present invention can stably maintain excellent solubility and removability for various stains for a long period of time.

<<Oil-Water Separability>>

1. Preparation of Cleaning Agent Composition

Each component was added and mixed so as to have a composition as shown in Table 9, to prepare each of the cleaning agent compositions of Examples 12 and 13.

The properties of the cleaning agent compositions shown in Table 9 were evaluated in accordance with the following methods.

<<Cleanliness>>

1. Preparation of Testing Substrate

One obtained by encapsulating TFT (thin-film transistor) liquid crystals in a gap between liquid crystal cells (gap distance: 5 μm), and allowing it to stand at room temperature for 30 minutes was used as a testing substrate.

2. Cleaning Test

A cleaning agent composition was warmed to 40° C., and a testing substrate prepared in 1. was placed in the cleaning agent composition, and subjected to ultrasonic cleaning (39 kHz, 200 W) for 10 minutes, and thereafter rinsed for 3 minutes in each of four pure water tanks (40° C.), and then dried with a hot air dryer at 90° C. for 30 minutes, to provide an observation sample.

[Cleanliness]

Liquid crystals remaining in the gap of the observation sample, and a mixture of liquid crystals not sufficiently rinsed off during rinsing and the cleaning agent composition were observed with a polarization microscope (magnification: 25-fold), to evaluate the cleanliness of the surface of liquid crystal cells. The cleanliness was evaluated by calculating a value obtained by dividing an area resulting from subtracting the entire area of portions in which the liquid crystals and the mixture of the liquid crystals and the cleaning agent composition remain from the entire area of the observed gap, by the entire area of the observed gap, and the cleanliness was ranked in accordance with the following evaluation criteria on the bases of the values obtained.

### [Evaluation Criteria]

⊚: 90% or more;
◯: 80% or more and less than 90%;
Δ: 40% or more and less than 80%; and

### X: less than 40%.

<<Repeated Cleanliness>>

In order to evaluate repeated cleanliness of a cleaning agent composition, a saturated concentration of the liquid crystals was examined. Twenty grams of a cleaning agent composition was warmed to 40° C., 0.02 g of TFT liquid crystals were added thereto, and the mixture was kept at 40° C. for 3 minutes. Thereafter, the mixture was visually confirmed, and the same procedures were repeated until the cleaning agent composition became white turbid, judging that the TFT crystals were dissolved if the mixture was transparent. The saturated concentration calculated by subtracting 0.01 g from the amount of liquid crystals at which the cleaning agent composition turned white turbid for the first time, and the obtained value was defined as a saturated concentration of the liquid crystals.

For example, assuming that the cleaning agent composition turned white turbid for the first time when adding 0.24 g of the TFT liquid crystals, the liquid crystal saturated concentration is calculated by the formula (0.24−0.01)/(20+0.24−0.01)×100. The repeated cleanliness was evaluated using the saturated concentration of the liquid crystals on the bases of the following evaluation criteria. The results are shown in Tables 1 and 2. Here, those ranked as ⊚ or ◯ were considered to be acceptable.

### [Evaluation Criteria]

⊚: 2% or more;
◯: 1% or more and less than 2%;
Δ: 0.5% or more and less than 1%; and

### X: less than 0.5%.

<<Rinsability >>

(1) Evaluation for Rinsing Water

In order to evaluate the state of rinsing water after rinsing, a 5% by weight aqueous solution of each cleaning agent composition was prepared as a pre-rinsing solution, and a 0.5% by weight aqueous solution of each cleaning agent composition was prepared as a rinsing solution, and the states of these pre-rinsing solutions and rinsing solutions at 60° C. were visually observed regarding whether or not the solution turned white turbid to evaluate a rinsing water. Here, as long as at least the rinsing solution did not turn white turbid, the cleaning agent composition was considered to be acceptable.

(2) Evaluation for Rinsability

<1> A 10% by weight aqueous solution (500 g) of each cleaning agent composition was heated to 60° C., and 18 pieces of glass panels (35×48 mm) to which TFT liquid crystals were deposited in an amount of 0.2 mg per panel were immersed into the aqueous solution for 10 minutes.

### <2> Thereafter, the panels were slowly drawn up over 20 seconds, and immersed into a first rinsing tank containing 500 g of pure water at 60° C. for 2 minutes.

### <3> The panels were drawn up from the first rinsing tank in the same manner as in <2>, and immersed into a second rinsing tank containing 500 g of pure water at 60° C. for 2 minutes.

<4> The panels were drawn up from the second rinsing tank in the same manner as in <2>, immersed into an extraction tank (ultrasonic tank) containing 500 g of pure water at 70° C., and treated ultrasonically (38 kHz, 400 W) for 10 minutes, and liquid crystals solubilized in the components of the cleaning agent composition remaining on the surface of the panels and/or the components of the cleaning agent composition were extracted.
<5> Next, the organic content of the rinsing water in each rinsing tank (first and second) and the extracted water in the extraction tank was determined by TOC (total organic carbon analyzer), and an oil content removal percentage in the first rinsing tank was calculated in accordance with the following formula.

### Formula:

$$\begin{matrix}\begin{matrix}Oil Content Removal \\ Percentage ( \% ) in\end{matrix} \\ First Rinsing Tank\end{matrix} = \frac{\begin{matrix}\begin{matrix}Organic Content Weight of \\ Rinsing Water in First\end{matrix} \\ Rinsing Tank\end{matrix}}{\begin{matrix}Organic Content Weight of Rinsing \\ Water in First Rinsing Tank + \\ Organic Content Weight of \\ Rinsing Water in Second \\ Rinsing Tank + \\ Organic Content Weight of \\ Rinsing Water in Extraction Tank \end{matrix}} \times 100$$

<6> The rinsability was evaluated from the oil content removal percentage calculated in <5> in accordance with the following evaluation criteria. The results are shown in Tables 1 and 2. Here, those ranked as ⊚ or ◯ were considered to be acceptable.

### [Evaluation Criteria]

⊚: an oil content removal percentage of the first rinsing tank being 90% or more;
◯: an oil content removal percentage of the first rinsing tank being 70% or more and less than 90%;
   Δ: an oil content removal percentage of the first rinsing tank being 50% or more and less than 70%; and

### X: an oil content removal percentage of the first rinsing tank being less than 50%.

### [Oil-Water Separability]

A cleaning agent composition solution prepared by diluting each cleaning agent composition with ion-exchanged water so that the components other than water are contained in an amount of 5% by weight was placed in a 100 ml glass bottle having a diameter of 40 mm and a height of 120 mm, and allowed to stand while keeping the temperature in an atmosphere of 60° C. for 1 hour. Thereafter, a state 1 of each cleaning agent composition solution was observed. In a case where the solution is separated into top and bottom two layers, the solution was stirred for 10 seconds by moving the glass bottle up and down thereby vigorously shaking the bottle, and further a state 2 was observed. The observation results were evaluated in accordance with the evaluation criteria shown in Table 8. The results are shown in Table 9. In both items, those ranked as ⊚ or ◯ were considered to be acceptable.

### [Evaluation Criteria]

TABLE 8

| Evaluation | State 1 | State 2 |
|---|---|---|
| ⊚ | separated into top and | separated into top and bottom two |
| | bottom two layers. | layers in less than 2 minutes after the |
| | | termination of stirring. |
| ◯ | separated into top and | separated into top and bottom two |
| | bottom two layers. | layers in 2 minutes or more and |
| | | within 5 minutes after the termination |
| | | of stirring. |
| Δ | separated into top and | not separated into top and bottom two |
| | bottom two layers. | layers in within 5 minutes after the |
| | | termination of stirring. |
| X | not separated into top | — |
| | and bottom two layers. | |

TABLE 9

| | Ex. 12 | Ex. 13 |
|---|---|---|
| Cleaning Agent Composition (% by weight) | | |
| Alkyl Polyglucoside*⁾ | 8.0 | 8.25 |
| 2-Ethylhexyl Glyceryl Ether | 0.5 | 2.0 |
| 1-Dodecene | 4.5 | 6.0 |
| Polyoxyethylene Alkyl Ether¹⁾ | 0.5 | — |
| Diethylene Glycol Monohexyl Ether | 4.5 | 2.95 |
| Triethylene Glycol Monobutyl Ether | — | 1.0 |
| Water | 82.0 | 79.8 |
| pH | 7.6 | 7.5 |
| Evaluation of Properties | | |
| Cleanliness | ⊚ | ⊚ |
| Repeated Cleanliness | ⊚ | ⊚ |
| Pre-Rinsing Property | Transparent | Transparent |
| Rinsing Property | Transparent | Transparent |
| Rinsability | ⊚ | ⊚ |
| Oil-Water Separability | ◯ | ⊚ |

It can be seen from the results of Table 9 that the cleaning agent compositions of Examples 12 and 13 have excellent oil-water separability. From the above, it is considered that the cleaning agent composition of the present invention is capable of reducing loads on wastewater by removing an oil content by oil-water separation.

### INDUSTRIAL APPLICABILITY

The cleaning agent composition of the present invention can be used for cleaning a silicone-treated tool contacted with a silicone which has been difficult to be cleaned. In addition, the cleaning agent composition of the present invention can be utilized for cleaning a liquid crystal-treated tool which is demanded to have a very high level of cleanliness. Further, the cleaning agent composition of the present invention can be suitably used for cleaning a copper plate usable in, for example, a precision part, a jig or tool, or the like.

1. A cleaning agent composition comprising an alkyl glycoside, a glyceryl ether, a hydrocarbon compound and water.

2. The cleaning agent composition according to claim 1, wherein the hydrocarbon compound is a compound having 10 to 18 carbon atoms.

3. The cleaning agent composition according to claim 1, further comprising a glycol ether.

4. The cleaning agent composition according to claim 1, further comprising an organic acid and/or an inorganic acid.

5. The cleaning agent composition according to claim 1, of which application is a silicone-treated tool.

6. The cleaning agent composition according to claim 5, wherein the proportion of each component to a total amount of the alkyl glycoside, the glyceryl ether and the hydrocarbon compound is 20 to 80% by weight for the alkyl glycoside, 2 to 30% by weight for the glyceryl ether, and 10 to 50% by weight for the hydrocarbon compound.

7. The cleaning agent composition according to claim 5, wherein the weight ratio of the alkyl glycoside/the glyceryl ether is from 2.7 to 10.

8. The cleaning agent composition according to claim 1, of which application is a liquid crystal-treated tool.

9. The cleaning agent composition according to claim 8, wherein the weight ratio of the alkyl glycoside/the glyceryl ether is from 1 to 10.

10. The cleaning agent composition according to claim 8, wherein the cleaning agent composition comprises 1 to 80% by weight of the alkyl glycoside, 0.2 to 80% by weight of the glyceryl ether, 0.1 to 80% by weight of the hydrocarbon compound, and 5 to 95% by weight of water.

11. The cleaning agent composition according to claim 1, of which application is a copper plate.

12. The cleaning agent composition according to claim 11, wherein the proportion of each component to a total amount of the alkyl glycoside, the glyceryl ether and the hydrocarbon is 20 to 80% by weight for the alkyl glycoside, 2 to 70% by weight for the glyceryl ether, and 3 to 50% by weight for the hydrocarbon.

13. The cleaning agent composition according to claim 11, wherein the cleaning agent composition has a pH of from 4 to 12.

14. The cleaning agent composition according to claim 11, further comprising an inorganic acid salt and/or a benzotriazole derivative.

15. A cleaning process for a silicone-treated tool, comprising the step of cleaning the silicone-treated tool with the cleaning agent composition as defined in claim 1.

16. A cleaning process for a liquid crystal-treated tool, comprising the step of cleaning the liquid crystal-treated tool with the cleaning agent composition as defined in claim 1.

17. A cleaning process for a copper plate, comprising the step of cleaning the copper plate with the cleaning agent composition as defined in claim 1.
